(19) United States
(12) Patent Application Publication
(10) Pub. No.: US 2014/0081729 A1
(43) Pub. Date: Mar. 20, 2014

(54) Systems and Methods for Providing Consumer Discounts

(71) Applicant: Alexander Ocher, San Jose, CA (US)

(72) Inventor: Alexander Ocher, San Jose, CA (US)

(21) Appl. No.: 14/027,820

(22) Filed: Sep. 16, 2013

Related U.S. Application Data
(60) Provisional application No. 61/703,271, filed on Sep. 20, 2012.

(51) Int. Cl. G06Q 30/02

(52) U.S. Cl. CPC G06Q 30/0222
USPC 705/14.23

(57) ABSTRACT

A method of managing a system for providing a discount is disclosed. The system includes obtaining payment instruments at a discount to their face value from a number of merchants and providing the user with a product to utilize these payment instruments. At the time the user purchases goods and/or services and in response to the user actions, the user account is associated with payment instruments to cover at least a portion of the total amount of purchase. The user is charged for the provided payment instruments and then can redeem them for at least a portion of the total amount of purchase. If a balance remains, the user is informed about it. A communication is sent to the user about the details of transaction.

### PRIORITY

This application claims the benefit of provisional patent application Ser. No. 61/703,271, filed Sep. 20, 2012 by the present inventor.

### FIELD OF THE INVENTION

The present invention relates to systems and methods for providing consumer discounts.

### BACKGROUND OF THE INVENTION

Gift cards are very popular money equivalents. They are usually either plastic cards or electronic cards. Gift cards are divided into “open loop” and “closed loop” cards. Open loop cards are issued by credit card companies and banks and can be redeemed at multiple merchants, while closed-loop cards are usually associated with and can be redeemed only at the specific merchant.

Closed-loop cards are often sold at discount when purchased in bulk (“corporate” or “bulk” purchases). Usually, the buyer needs to commit a substantial amount of money to receive such a discount; another disadvantage is that the buyer locks in money that can be used only at one merchant. They usually cannot be returned back to the merchant for cash, so the customer is stuck with them.

Gift card aggregators, such as Cardpool, are trying to address the issue by buying unwanted gift cards and selling them to the public. However, these companies don't have a stable supply of gift cards and many gift card owners are reluctant to sell their cards at a steep discount.

The US patent application 20120191513, filed by the present inventor, tries to address the issue by using bulk purchases of gift cards from multiple merchants and sharing the discounts with the users. However, it still requires the users to pre-purchase the cards.

Therefore, there is a need to provide a system that enables the consumers to get ongoing savings on their purchases without requiring them to prepay or getting locked with a single merchant.

### SUMMARY OF THE INVENTION

The features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Various embodiments of the present invention provide systems and methods for providing consumer discounts. In a disclosed preferred embodiment, the consumer gets a smartphone application (520), and can purchase (560/570) and use (580) merchant electronic gift cards at the point of sale. If these cards do not cover the entire amount of purchase, the user is informed about the remaining balance and can use other methods of payment to complete the purchase (590).

In a further embodiment of the invention, gift cards are purchased (500) by the owner of the system at a discount. A portion of this discount is shared with the customer.

In another embodiment of the invention, the system is connected to a processor in the authorization request processing chain, such as POS systems of participating merchants, merchant acquirer, card association, or a bank. The owner of the system registers (300) and prefunds (110/310) a merchant bank account(s) and/or enters into an agreement with the merchant, and gift cards are purchased by the owner of the system at a discount. After a user is enrolled in the system (120/320), a request is generated by the backend system (130) for a card or smartphone application. The user is provided with the card or application (140/330) and optionally activates it (340). At the processing time, an attempt is made to match the customer information against a database of registered user records. If such a match is found, the request is routed to the system (170/360) that may apply additional deals to decrease the total amount and then charges the preferred method of payment in the user record (180/370). A policy and/or rules can be established to manage the selection of the preferred method of payment. Then, the account that provides a discount for the merchant that initiated the transaction is debited and the merchant's account is credited (200/380). Subsequently, the transaction is authorized if all steps were completed successfully (230/390).

Note that the various features of the present invention described above may be practiced alone or in combination. Further features and advantages of the present invention as well as the structure and operation of various embodiments of the present invention are described in detail below.

### BRIEF DESCRIPTION OF THE DRAWINGS

FIG. 1 is a flowchart depicting exemplary process of the system for providing consumer discounts in accordance with one embodiment of the present invention.

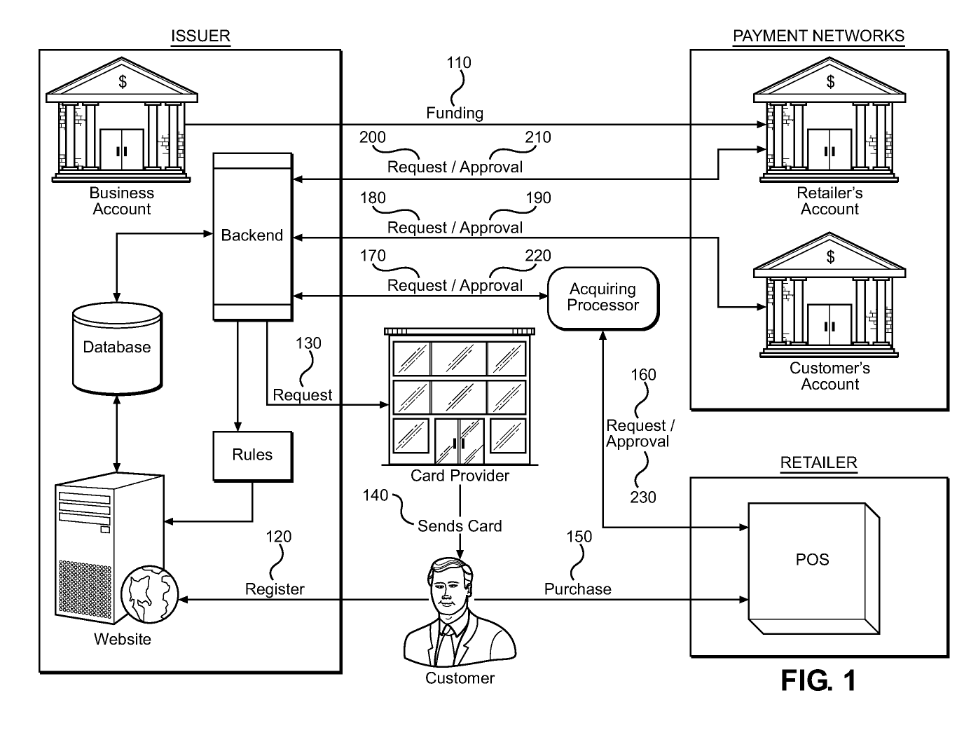

FIG. 2 is an example block diagram that illustrates operations associated with enrollment and transaction processing scheme in accordance with one embodiment of the present invention.

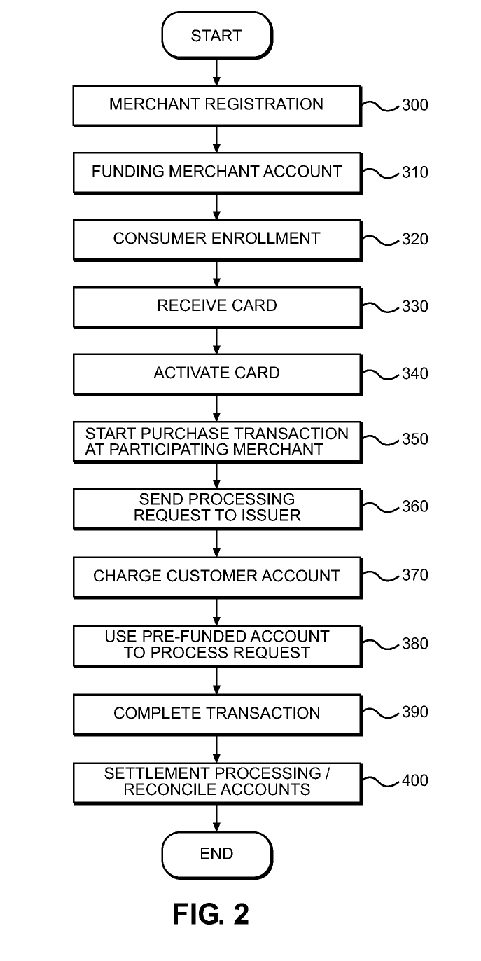

FIG. 3 is an example block diagram that illustrates operations associated with purchasing and transaction processing scheme in accordance with a second embodiment of the present invention.

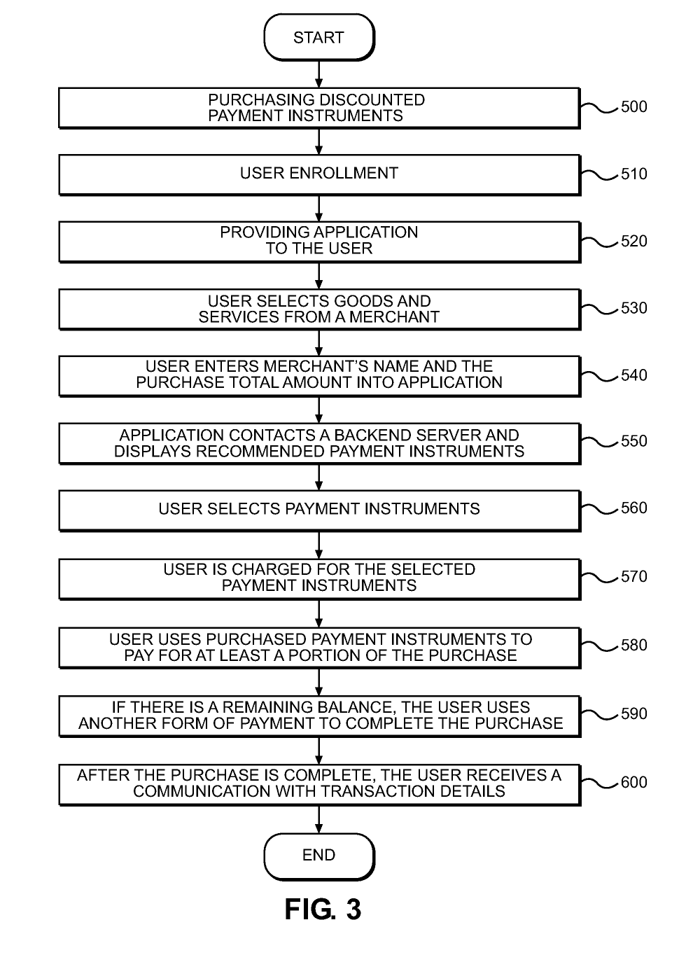

### DETAILED DESCRIPTION OF THE PREFERRED EMBODIMENT

To best describe the preferred embodiment of the instant invention, a list of steps for system operations is provided:
a. Buy discounted eGift cards (500);
b. Enroll a user (510);
c. Provide a smartphone application (520);
d. User selects goods and services at a merchant (530);
e. User enters merchant name and the purchase total amount into application (540);
f. Application contacts the backend server and displays the recommended eGift cards for the purchase (550);
g. User selects the cards to purchase (560);
h. System charges the user for the selected cards. The cards now belong to the user (570);
i. User uses these eGift cards to cover at least a portion of the purchase (580);
j. User uses another form of payment, such as credit card, to pay the remaining balance if any (590);
k. When the purchase is complete the user receives a communication with transaction details (600).

The systems and methods of the invention provide discounts to their users. The present disclosure describes new and improved method and associated concepts to allow the consumers to receive the benefits of discounts and awards on their purchases in stores, over the telephone, from mobile applications and online.

An exemplary system that can be employed to practice the concepts may be implemented as a software application that is provided by the owner of the system and runs on the customer's mobile device such as tablet or smartphone or wearable device such as smart glasses or watch (520). Users register with the system (510) and provide one or more payment methods.

The customer selects goods and services at a merchant (530). When the total amount of purchase is known, the user enters merchant name and this amount into the application (540); this information may also be obtained via use of image scanning, location services and electronic communications with merchant-provided system.

The application checks the available cards and proposes a combination (550). For example, if the total purchase amount is $84.25, the system may propose three eGift cards: $50, $20 and $10. The user may have an option to specify the maximum number of cards to display, and may decline to purchase any of the cards (for example, buy $50 and $20 in this example and skip $10), etc. The system may also show via a Web site or mobile application the available denominations for gift cards for the customer to choose from.

The application sends the request with user selections (560) to the backend system. The backend system attempts to charge the user (570) using the best payment method(s) that is determined by the system or pre-selected by the user. If transaction is approved, the eGift cards can be used by the user to pay for the purchase (580). Continuing with the example, the user would pay $80 with eGift cards and the remaining $4.25 with another method of payment (590), such as a credit card or a digital representation of a payment method using a graphical image, 2D/3D/QR optical code, biometric or near field communication (NFC) data.

If all steps were completed successfully, the user gets a confirmation with transaction details (600). For example, if the cards were offered at 5% off to the user, the confirmation would indicate that the user received $80 worth of gift cards, but was actually charged only $76. These savings are on the top of any coupons, promotions and other deals that the user may have used for the purchase and also can be combined with cashback and other benefits provided by the user's method of payment that was charged for eGift cards.

This is a brief introductory description of a basic system and method that can be employed to practice the invention. A more detailed description of various embodiments of the disclosure is discussed in detail below. While specific implementations are discussed, it should be understood that this is done for illustration purposes only. A person skilled in the relevant art will recognize that other components and configurations may be used without parting from the spirit and scope of the disclosure. Any particular function disclosed in connection with one embodiment or aspect can expressly be integrated into another disclosed embodiment, function or aspect. This disclosure considers mixing and matching of the various functions although particular functions are not specifically discussed in one example.

In another embodiment, the system may be implemented as a card (gift card, prepaid/debit card, etc.) that is issued by the owner of the system. Users apply or register (120/320) to receive the card (140/330) and provide one or more payment methods. The card may also show activation information instructing the customer how to activate the card (340).

The customer makes a purchase (150) by using the card. The point-of-sale system sends the data (160/350) to payment processor. The processor routes the request to the system's owner (170/360). The transaction request may include information about the merchant, location, amount of purchase and the items that are purchased, among other things. Any additional offers are applied to achieve additional savings and the best payment method(s) is determined by the system or pre-selected by the user. The system charges this payment method (180/370) and then selects the best method to pay the merchant (200/380). The method that is used to pay the merchant provides a discount or savings that is shared with the customer (110/310—system gets discount from a merchant; 180/370—customer gets discount from the system). The discount is provided for the pre-payment of funds and/or aggregation of purchases for the merchant or per agreements with merchants.

If all steps were completed successfully, the transaction is authorized (220) and the user gets a confirmation. Later, there can be some fund transfers and re-allocations to settle the transaction (400).

The application or card may be linked to a plurality of accounts. If the card has reprogramming capabilities, its state can be managed by using a suitable interface, either wired (USB, Firewire, etc.) or wireless (NFC, RFID, etc.). For example, it can be updated and the desired configuration can be selected either locally, by using a personal computer/mobile device or its attachment, or this information can be changed on the system's backend, by using a native or Web application. In addition, once the information about different accounts (such as gift cards for different merchants) is transferred to the card or is preprogrammed into it by the owner of the system (for example, each card may receive a set of unique account numbers for all participating merchants when it is created and/or activated), the selection of the desired card to be used at a merchant can be done on the card itself using any suitable mechanism such as touchscreen, electronic switch, etc. For example, a record on the card may contain merchant's name and the corresponding account, or it may contain other information, such as merchant logo, associated amount, etc. The number may be a temporary/generated account number, a coupon or coupon basket, etc. The reprogramming may include, but is not limited to, changing the data in the chip memory, changing the information on the magnetic stripe, etc. Security measures may be taken to make sure that this information remains confidential and protected from unauthorized access.

The card itself may be any of a smart card, a virtual card, an application on a mobile device, a device with USB or another communication interface, or a typical physical (plastic or paper) card. If it is a smart card, it may include a chip, a transmitter, a camera, a screen/touchscreen, a biometric sensor, and/or a power source. If capable of transmitting, the card can use the spectrum range from radio frequency to ultraviolet to transmit and small changes in EM intensity (or changes in wave length) can also be used for communications. Transmitters/receivers for this range are well known, although not all of them are currently used for card processing. The power source includes any of solar power, battery, fuel cell, piezoelectric materials and external voltage differentials. The power source may be contact-less, such as electromagnetic or ultrasound waves, and the resulting energy may be stored for later use. Physical cards may be plastic with an optical identifier or magnetic strip. The card may also be branded or customized. The card may also be associated with a financial account of the user.

The card type can be a gift card, a pre-paid/debit card with possible reload option or a stored value card. Also, it can be a new type of payment in addition to existing ones.

While the term “card” may be utilized within the specification to delineate the means of identifying the user account to a merchant, this term is not intended to be limiting, but rather is intended to convey any account identifier, such as mobile device application, mobile wallet ID, biometric data (used via any suitable detection mechanism such as touch screen, camera, bio-censor, etc.), passcodes (QR code, 2D/3D barcode), hashtags, smartcards, RFID chips, or any other conceivable identifier. The account balance, user linked information and the like may be stored upon a cloud or other backend system. The “card” is merely a means for accessing this stored information. As such, a user may have a mobile application “card” and a traditional plastic card linked to the same account information. Further, the “card” may merely be a username or social network identifier and password combination that is remembered by the user, biometric identifier or any other authenticating system. In this example, the username and password could be input at the cash register of a merchant to pay via its linked account.

The card or application may have a PIN (either changeable by user, or dynamic, such as changing with time or after each transaction) or other authorization and security measures associated with it, such as biometric measurements (including voice and face recognition, fingerprinting, and nano-crystallization) or an alphanumeric password. If the card is issued by the system's owner, it may also need to be activated using any suitable mechanism (or, it can be sent already activated).

Payment options may be set by the consumer during registration (120/320/510), such as a debit/credit card account, a checking/savings bank account, a gift card account, merchandise credit, a health savings account, online account such as PayPal, mobile payment account such as Dwolla, digital currency account such as Bitcoin account, etc. The user may register more than one payment method and select rules to use different methods for different purchases. Membership/loyalty information may also be provided.

In one embodiment, user information is associated by the system with the identity of the user, and may include global unique identifier (GUID), personal account number (PAN), account number, customer number, social security number or equivalent, loyalty/membership record and/or other user data. This information may be used for the Patriot Act compliance and other mandatory compliance purposes. The user's information can be completely stored in the backend system, or may at least partially reside on a user's electronic device.

This information may be changed by the user at any time via a Web site, a telephone system, a paper mailing, or a smartphone application. The information is saved in a secure server system.

In the alternative embodiment, the customer makes a purchase (150) by using the card, and generates an authorization request (160/350). This may include swiping the card at the POS terminal, giving a voice command to a wearable smart device, waving or tapping a mobile device, using an attachment for a mobile device, entering alphanumeric text/pushing a button on a Web site or sending a text message, scanning an optical code, fingerprint detection, iris scan, typing the card number, providing phone number or social network ID or other method of identifying the user to the point of sale. A mobile device also may communicate with point of sale device(s) using LAN/WAN, Wi-Fi, cellular network technologies, messaging service, or short-range connections such as Bluetooth and NFC (either integrated into the device or enabled via a sticker or hardware attachment). For reprogrammable cards, it may include selecting the right account, for example the correct merchant account, for the card or generating a unique code, either by itself or with help of a mobile application, that can be communicated to the point of sale. The request may also be a token or a partial identifier that is sent to another entity to retrieve the full authorization details associated with the user before sending the request to payment processor.

A customer who is not in physical possession of the card enters a number or another form of identification associated with the card into the point of sale.

The term “point of sale” is used as a generic term to identify any device or method of entering users information. It can be a POS terminal, an online checkout system, a telephone system, an email or text messaging system, or it may represent a virtual concept that may be a system to pay customers debt with possible setup fees; automatic bill payment system, etc. It may need to be able to turn off or ignore balance check and BIN check results.

All participating merchants and their available discounts are listed on the system's owner Web site. These merchants may also indicate the acceptance of the card by using its brand mark, such as online logo, door decals and point-of-sale signage. A location-based app can also be used to let the user know that the system provides a discount to a nearby business. The system's owner Web site may also be integrated with at least some merchants, so the customers may purchase some products directly from these merchants by using an application or card at a discount and/or using special offers.

In a preferred embodiment, the processing can be accomplished without the active participation of the merchant so merchants may not need to be aware that an additional processing takes place. In other embodiments, merchants are actively participating in the program.

In a preferred embodiment, merchant and/or purchase information can be obtained by an application in a number of ways, including manual entry, geo-location, scanning receipt or POS screen or terminal bar codes, Wi-Fi, short-range communications technologies such as RFID, Bluetooth and NFC, transmitted through touch, electric field sensing, etc. These communications may be supported directly by a smartphone or via a hardware attachment. The POS system may combine several pieces of data, such as merchant identification, terminal ID, purchase amount, loyalty/club card information, list of items, etc. into one identifier that is provided to the application via any suitable communication method. So, it can be either manual, semi-automatic or automatic. It can even be initiated by the checkout system instead of the customer, for example, by authenticating the customer using face and/or voice recognition software or obtaining the customer fingerprint on a biometric reader that communicates with the user's smartphone.

The application can be branded and/or customized by the system, users, or merchants to customize the shopping experience in a particular merchant's stores. For example, it can show price and popularity trends, coupon and gift card reminders, reviews and historical data. Merchants can show their brand information and provide the list of products or services, items on sale, special offers, pre-ordering services, bills of materials and recipes, etc. Customers can add their shopping lists, notes, limit their spending and share their purchases with others. Implementation may include deployment of smaller applications, custom linked apps, web links, or templates, etc. The application may also serve as a platform to store other payment and non-payment digital information such as various forms of identification, electronic keys, provide personal finance tools, etc.

In the alternative embodiment, the point of sale system sends the authorization request (160/350) to the processor, preferably utilizing the existing payment infrastructure. The processor can be a POS system, merchant server, acquirer, card association, or a bank. Examples of merchant acquirers include Chase Paymentech, First Data, Heartland Payment Systems, etc. Examples of card associations include VISA, MasterCard, Discover, etc. Examples of banks include Citibank, U.S. Bancorp, Wells Fargo, etc.

The payment process may involve all of these entities, or some of them may be missing. This system and method can be integrated with any of these entities. For example, the POS terminal may send a transaction request to the merchant acquirer, which would route it to the system (170/360); or a request may come from an online checkout system and it will reach the bank that is integrated with the system; or, the POS terminal itself may send the authorization request directly to the system; etc.

The owner of the system may also implement its own payment platform. For example, a transaction may be initiated on a Web site of an online merchant and be routed to a social network company that provides its own payment system and discounts to customers.

More than one payments network could be employed to connect different elements of the system.

In the alternative embodiment, the processor routes (170/360) the request to the system's owner based on the card BIN/IIN number (PAN first 6 digits), or another indication.

The system receives the request and attempts to charge the selected method of payment (180/370) as determined by associated rules. For example, if there is an ongoing promotion to receive a $50 Target gift card when the customer charges at least $2,000 to his/her VISA credit card in the current month, then the VISA card may be selected as the preferred method of payment. The merchant may want to use this opportunity to create and track customer loyalty. Additionally, merchants may target particular customers and offer discounted rates to consumers who present such cards or to motivate the customers to perform additional predetermined activities to get additional rewards. There can be a cost to the merchant or other entities associated with any optional features of the system, for example, value added services such as couponing and loyalty.

In case of more than one payment methods associated with the user, the user and/or system selects one to be used for purchases based on the rules that depend on the purchase information. If the payment method selected is a merchant's gift card or a bank account, a backup source of funding may be selected. The user may be prompted to set the payment method as default for transactions with the merchant. The chosen payment method, for example, may be based on received the greatest benefits for completing the transaction. Additionally, it may take into consideration other factors such as the maximum amount of reward points that can be used for a transaction, transaction amount, account balances and limits to avoid overdraft fees and interest rates on different credit cards, geographic location, etc.; this information may be retrieved from third party sources and/or provided by the user or device. There can be more than one payment method charged for each transaction and the preferred payment method may be a combination of several funding sources. The user record can also be integrated with pre-existing user accounts that are associated with one or more payment methods.

The rules for choosing payment methods can be based on current offers such as deals, coupons, loyalty points, etc. For example, it may be advantageous to a consumer to use a particular card to make purchases based on a favorable interest rate or other reasons. These rules may be pushed to the user via API, may need user approval and the providers of these offers may be charged some fees. The rules may also allow multi-merchant deals that take into account purchases at competing or cooperative merchants. Coupons may be automatically applied from database of available offers which can be updated by merchants or from Internet. Also, the payment methods may include offers such as those provided by companies like Groupon that were purchased by user, or the system may query those deal companies and purchase additional deals in real time to maximize user benefits. These deals may be used to lower the total price of the purchase.

In the alternative embodiment, different currencies, including digital and virtual currencies, may be used in the different parts of the transaction process. These currencies may also include loyalty points and social currencies. The currency conversions, if needed, are managed by respective parts of processing system. In some implementations, the program provider may set the exchange rates.

Some implementations may include sending screen information back to the customer to inform of actions taken and/or to ask additional questions and/or to confirm a specific action on a POS device. Alternatively, these offers, messages and questions may be sent to the customer's electronic device.

The system receives (190/210), processes and stores approval and authorization codes from all payment sources that participated in the transaction. It also may log the transaction related information for billing and tracking purposes.

In a preferred embodiment, after the system charges one or more payment methods associated with the customer (570), the discounted payment instruments such as hashtags, text codes, email attachments or 2D/3D/QR optical codes are delivered to the customer by using an email or text message, displaying them in a mobile application or using another method to associate them with the customer record. The total amount of value associated with these payment instruments may cover a part of total purchase, the full amount or may even exceed that amount. The customer can use them immediately for the purchase (580), or may decide to save them for future use. The customer may also decide to send these payment instruments to others via communication methods such as email, Bump technology, in-app electronic funds transfer or social network, either using the same or different software application.

Instead of buying payment instruments to be applied to the user's purchase, the card or application can send a direct payment request to the backend processing system of the present invention. A one-time use code may be generated to assure the security of the request. This request may be triggered by either the customer or the merchant's POS system such as self-checkout. If the request is approved, a payment confirmation message is sent to at least one of the following: the point of sale device and the customer's device. This proof of payment may require action from the user, such as pressing a button or providing a signature on a touch screen, and can be communicated between the customers device and POS system in a number of ways, such as visual confirmation, short range electronic communication, optical scan or integration with the merchant checkout system. Additional authentication measures such as digital photo identification may also be applied to make the solution more secure.

In the alternative embodiment, while processing transaction, the system may receive transaction details such as loyalty/club card information, merchant ID, terminal ID and list of individual items that contain product identifying information (SKUs, model numbers or UPCs/product category IDs). A database of offers such as coupons and limited-time deals may be searched to determine whether there are any discounts that can be applied to the transaction. The offers may also take into account the history of previous purchases at one or more merchants. The new (possibly lower) total amount is then calculated.

A suitable interface, such as a Web site, file transfer, API, etc. can be provided for the merchants and/or other parties to add, update or modify additional discounts or offers. These offers can be presented to the customer in advance (and may require prepayment), or can be offered at the point of sale as real-time responses to authorization requests. Merchants may monitor these promotions and change them at any time.

The database of offers may also be populated by searching the Web for deals offered by various merchants. The database may also include deals from merchants where the discounts are not currently available or multi-merchant deals.

All merchants can be in the same category (restaurants, movie theaters, etc.) and the system's owner may decide to offer several card lines to serve multiple categories with possibly different discount rates (merchant- or category-dependent); or they can be from multiple categories and use only one card line. If both generic (base) and category-specific cards are implemented, the base cards should still be accepted everywhere a category-specific card is accepted. Alternatively, multiple card lines or account types can be implemented based on discount level (for example, bronze, silver and gold for 7%, 8% and 10% discount levels).

The discount that customers receive may be based on the discounts provided by merchants. For example, if a merchant provides a 10% discount, then the customer will receive 5%; however, if a merchant provides a 5% discount, the customer may receive only 3% discount. Alternatively, the customer discount may be fixed, for example 5%, but the number of merchants that are allowed to use the card varies based on the second method of payment: for example, if the customer specifies a payment method with low fees, such as bank account, then s/he can get this discount at more merchants than if a more expensive payment method, such as a credit card, is used.

There are other ways to establish the discount structure. For example, the discount may increase depending how much the customer spends in general or per merchant. The discount may be set to the same level, for example 5%, for all merchants and the owner of the system may be taking a loss at some merchants that is offset by profits at other merchants. The discount levels may also be based on rules that may use predictive and statistical methods and also can be based on other factors such as popularity. Or, discounts can be based on service-level agreements (SLAs) with merchants: different agreements with different merchants, discounts based on the number of users and/or total purchases using the card during a predetermined period of time, etc.

The discount level can also determine the card's acceptance: lower discount will provide a higher acceptance (more merchants). In addition, the discount may be, at least in part, based on how often the user shops at a specific merchant.

When the amount of available funds invested in payment instrument for a particular merchant drops below a pre-defined threshold, fund additions at a discount can be performed via any suitable interface (API, buying cards from merchant and/or secondary markets, etc.). The numbers (initial funding amount, etc.) can be the same for all merchants or vary between merchants.

Merchants may have a physical presence or they can be pure online companies; the card value can be in a regular currency (for example, USD) or in virtual currency (online credits) or some other variation (such as a hybrid currency, electronic money such as digital currency, etc.).

In the alternative embodiment, if the charging attempt was successful (190), then the system selects the method to pay the merchant. This method may be a merchant's pre-set account, such as gift card account (for example, purchasing bulk gift cards in advance to cover merchant's setup expenses, demonstrate commitment, etc.). The pre-set account can also be a bank account, where the owner of the system would deposit the funds (110/310). Instead of, or in addition to, the prepayment, the discount can also be based on SLAs with merchants.

The selected payment method is then used to pay the merchant (200/380). For example, the funds may be loaded on the debit card or gift card account associated with the card that was provided by the owner of the system (for reprogrammable cards, it can be the corresponding merchant's gift card account) and then used for the payment; or a merchant's pre-funded bank, another bank account or gift card account may be used. If merchant's bank account is used, there may be no need to transfer money: the system may debit the customer financial account and credit the merchant account. Alternatively, for prepaid/gift accounts, the payment to the merchant may not be in real time by providing another source of funds as a guarantee of payment. The guarantee may also come from the owner of the system posting collateral which can cover the largest permissible purchase (liability account).

The payment instruments can be used for man-to-machine payments (vending machines, parking, tickets, etc.), including micro-payments. To minimize the processing fees, small payment transactions may be aggregated. The payment to the merchant can be an actual payment or payment guarantee.

The payment instruments are associated with the user either at registration or at first purchase by either a permanent account number associated with the merchant or a temporary code. If a permanent merchant-specific account is used, then a small merchant-dependent initial amount, obtained by the system at a discount, may be put into this account. At the time of purchase, the final purchase amount will be transferred by the system to that account, and, after the purchase is complete, the initial amount will remain associated with the merchant-specific account of the user.

The discount is shared between the system's owner and the customer.

In addition to, or instead of, the customer discount, the customer may get back a portion of the amount paid. In some implementation, especially if there is a cost associated with each fund transfer, it may be advantageous to do the transfer when funds accumulate above a certain threshold or in a certain time period (for example, monthly); in other implementation, the transfer can be instant. The funds/savings can be used to realize user benefits such as purchasing financial instruments such as merchant or open-loop gift cards (possibly at a discount), paying debts (credit card, mortgage, college loans, etc.), go to a digital/virtual currency account such as BitCoin, retirement savings plan, health savings account, charitable giving or other purpose.

The user may pay the full transaction price (minus any offers) at the point of sale, and then get a rebate later. Also, the system may pay the full price to the merchant at the time of purchase and later receive a rebate or cashback from the merchant. Another entity (not the system) may also provide at least a portion of funds to buy the payment instruments in exchange for a return, for example, advertising rights.

In the alternative embodiment, if all steps were completed successfully, the transaction is authorized and the response is sent back (220) to the payment processor. The point of sale receives the authorization (230/390) for the full (non-discounted) amount. In other embodiment, a partial approval is returned and a split-tender transaction is performed.

The system notifies the user about transaction completion via a suitable method such as an email, text message, posting on a social network site, etc. The notification may include, for example, the total discount that was applied to the purchase.

In the alternative embodiment, in case when one of the steps above fails, the system will revert back all the transactions performed and send rejection code back to the point of sale.

In case of failure, the system notifies the user via any suitable interface such as email, phone call, text message, mobile application, etc. In some embodiments, if the user method of payment was not successfully authorized and there are other payment methods provided by the user, the system will try to use these payment methods in the order that is specified by the user or associated rules, and the transaction will be denied only if no suitable method of payment is found. In yet another embodiment, locally stored (for example, on a smart card or mobile device) credits may be used to complete the transaction even if the link to the payment network is not available.

In some embodiments, the system may not charge the user's method of payment immediately and credit may be extended by the system to all or some users, when the system fronts the funds to the merchant and invoices the customer at a later date. Some additional checks may be performed or pre-approval may be required prior to offering a credit and the options available to the user may be based on the results of these checks. The amount of credit that was extended to the user is maintained as a part of the user's record.

In the alternative embodiment, after a transaction has been authorized, there can be a reconciliation process (400), for example to reconcile the payment methods presented at POS with the actual financial instruments used to pay the merchant, or full amount with discounted amount, during settlement: in one embodiment, the original transaction is canceled/reverted (possibly as a merchandise return transaction) and a new/additional one is recorded. The transaction ID can be used to retrieve payment/authorization details as well as information about additional deals and rewards. If the authorization response used the hold amount field for the entire amount of the transaction or its portion, the hold is released. The transaction log and settlement files may be updated and sent to all parties involved, the necessary funds are applied to the remaining settlement amounts and the transaction is settled with one or more financial institutions.

The merchant may or may not be aware that another method of payment (other than the ones used by the user at the point of sale) was used. If merchant involvement is not required, then the necessary steps may be performed by the system with or without help of a payment processor: for example, gift card balance may be obtained using data scraping or extraction techniques instead of sending a balance request to merchant card program.

These systems and methods may be used by the owner of the system or they can be licensed to third parties to provide a turn-key user-discount solution and other related services. For example, they can be used by merchants that do not have a gift card program to provide one that is managed by the owner of the system.

This system and method can also be made available for third parties for integration via a suitable interface. For example, an application programming interface (API) may be provided so as to allow third-party developers to use the system services provided by the invention. Additional services may also be available, for example, a subscription service to receive notifications when a user makes a purchase, uses a manufacturer's coupon or selects a specific method of payment; or a social networking service which connects purchases in stores and online with the user's social network information, providing a basis for targeted online advertising.

The system can be integrated with other mobile payment solutions such as Google Wallet and mobile POS/checkout systems. Some of these systems may allow a secure checkout even if there is no network connection available. It may also be integrated with other POS applications such as self-checkout or location-based advertising.

Any and all of the communications needed to implement the invention may be secured to prevent unauthorized use, for example, encrypted. Any wireless communications may use the radio waves to ultraviolet range of the electromagnetic spectrum.

Reference to “owner of the system” and “system's owner” means any entity that either developed, licensed or otherwise permitted to practice this invention in any form. It can be a merchant, a processor (merchant acquirer, card authority, bank, etc.) or a third party entity.

In certain instances, well known or conventional details are not described in order to avoid obscuring the description.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

The foregoing description, for purposes of explanation, used specific nomenclature to provide a thorough understanding of the invention. It will be appreciated, however, that embodiments of the invention can be in other specific forms without departing from the spirit or essential characteristics thereof. The described embodiments are not intended to be exhaustive or to limit the invention to the precise forms disclosed; obviously, many modifications and variations are possible in view of the above teachings. The presently disclosed embodiments are, therefore, considered in all respects to be illustrative and not restrictive. The embodiments were chosen and described in order to best explain the principles of the invention and its practical applications; they thereby enable others skilled in the art to best utilize the invention and various embodiments with various modifications as are suited to the particular use contemplated.

What is claimed is:

1. A method for providing user discounts comprising the steps of:
a first entity purchasing a large number of payment instruments from at least one second entity at a discounted rate;
said first entity registers users that agree to commit to a set of rules determined by said first entity;
said first entity allocating said payment instruments among said registered users by determining their need at a time and point of sale;
said users redeeming said payment instruments to complete their purchases.

2. The method for providing user discounts of claim 1, wherein said first entity acquires information about said at least one second entity and maintains an accessible database of all information collected per said at least one second entity.

3. The method for providing user discounts of claim 1, wherein said first entity acquires personal information from each of said users during said registration and creates and maintains an accessible database of all information collected per registered user.

4. The method for providing user discounts of claim 3, wherein said database of registered users is updated by the actions of said users using a method chosen from a list of methods consisting of a dedicated web site, a telephone system, paper mailings, and an application.

5. The method for providing user discounts of claim 2, wherein said at least one second entity information includes at least the identification information, contact information, and available payment instruments or balance for said at least one second entity.

6. The method for providing user discounts of claim 3, wherein said personal information includes at least a user's name, address, and at least one payment method.

7. The method for providing user discounts of claim 6, wherein said payment instruments are chosen from a list of payment instruments consisting of credit and debit cards, gift cards, bank accounts, online and alternative payment methods, and alternative currencies and credits; and wherein information about said payment instruments can be stored in a backend system or can partially reside within an electronic device of said user.

8. The method for providing user discounts of claim 7, wherein said payment instruments are adapted to be governed by at least one of the following rules such that a more efficient use of said payment instruments or rewards can be achieved:
in case of more than one payment instruments associated with the user, the user may select one to be used for purchases until another one is selected;
in case of more than one payment instruments associated with the user, one instrument may be selected to be used for a purchase based on the rules that can be based on the purchase information, account information for the payment instrument and current offers that can be pushed to the user via API and may need user's approval;
in case of a payment instrument being a bank account or a merchant's gift card, a backup source of funding may be selected;
in case of the user supplying loyalty and membership account information, this information will be associated with the user's record.

9. The method for providing user discounts of claim 1, wherein said discount is obtained by any the following or a combination thereof:
said first entity buys payment instruments at a discount in advance, said discount provided for the pre-payment of funds, for example, by purchasing gift cards in bulk from said second entity or by depositing money into bank account of said second entity and investing more funds, also at a discount, when the available amount drops below a threshold;
said discount is provided for the aggregation of purchases for said second entity or per agreements with any of second entity;
said first entity buys payment instruments at a full price and later gets a discount or rebate from said second entity;
said at least one second entity may provide said payment instruments to said first entity on demand in exchange of payment guarantee and then bill the aggregate amount later.

10. The method for providing user discounts of claim 9, wherein said discount is shared with the user, using any of the following methods or a combination thereof:
said user discount may be the same or different for different second entities of claim 1;
different user discount levels may be associated with different card types and may be based on various factors such as said second entity categories, discounts, popularity, the rules that may use predictive analytics and other factors such as participation fees and shopping frequency;
user discount level may remain the same for all of said second entities but the number of these entities where said user discount can be obtained varies based on the user method of payment in claim 8.

11. The method for providing user discounts of claim 10, wherein said user discounts can be combined with additional discounts and rewards for the user purchase to further increase the savings; and where at least some of said additional discounts and rewards can be added, modified or otherwise controlled by said second entities using suitable interface such as web sites.

12. The method of claim 1, further comprising providing the user with a product with a unique identifier to utilize said payment instruments associated with the user account by said first entity, wherein the product may be any of a mobile device application, a social network application, a smart card with possible reprogramming capabilities, an RFID card, a scan code, an internet application, an e-mail message, a text (SMS/MMS) message, a laser optical card, an NFC-enabled device, a USB device, or a plastic card with at least one of an optical identifier or magnetic strip; wherein said product may be branded and customized by said first entity, any of a second entity and users to improve shopping experience; and wherein said product incorporates unique identifier therein, such that said product can be associated with an appropriate account of each registered user.

13. The method for providing user discounts of claim 12, wherein said product of each individual user account is protected from unauthorized use by incorporating a method chosen from a list of methods consisting of a static PIN, a changing PIN, cryptography, biometry, and personal information verification.

14. The method for providing user discounts of claim 8, wherein said first entity charges the user for said payment instruments using said payment methods associated with the user, wherein said charging includes at least one of the following:
charging the user a discounted price for said payment instruments; charging the user the full price for said payment instruments, while transferring a pre-defined portion of the total amount of purchase to be used for user-defined purpose;
charging the user the full price for said payment instruments and providing a rebate after the purchase;
charging the user after the purchase is complete;
charging the user and initiating the payment to said second entity, providing with the proof of payment at the point of sale.

15. The method for providing user discounts of claim 1, wherein said payment instruments are associated with the user either at registration or at first purchase by either a permanent account number associated with said at least one second entity or a temporary code, and are provided to the user either via the product of claim 12 or other means of communication such as either an email message or text message; wherein said payment instruments may be in the amount to cover or exceed the full purchase amount or they may cover just a part of it.

16. The method for providing user discounts of claim 15, wherein said payment instruments are now owned by the user and may be utilized in any of the following ways:
redeemed for at least a part of the purchase at said at least one second entity, in a payment transaction that is initiated by either the user or said second entity;
be sent to anybody using a suitable communication channel such as an email or text message;
saved for later use by the user;
the user can request a redemption for cash or credit if allowed by said first entity.

17. The method for providing user discounts of claim 8, wherein the redemption process for said payment instruments may involve routing the request for authorization of the payment for additional processing by said first entity and different currencies, including digital and virtual currencies, may be used in the different parts of the transaction process.

18. The method for providing user discounts of claim 1, wherein said first entity provides a notice to the user about obtaining and redeeming said payment instruments: confirmation and transaction details in case of success, rejection reason in case of failure.

19. A method for providing user discounts comprising the steps of:
purchasing discounted payment instruments;
enrolling a user via an interaction with an internet enabled electronic device;
providing a software application on a mobile or wearable device to said user;
said user selecting goods and services from a merchant;
said user entering said merchant's name and the purchase total amount into said application;
said application contacting a backend server and displaying recommended payment instruments for the purchase of said goods and services;
said user selecting payment instruments to use for said purchase;
charging said user for the selected payment instruments, such that said payment instruments are then owned by said user;
said user then uses said payment instruments to pay for at least a portion of said goods and services;
said user then uses another form of payment to pay the remaining balance for said goods and services;
after said purchase is complete said user receives a communication with transaction details of said purchase.

20. The method for providing user discounts of claim 19, wherein said another form of payment includes forms of payment chosen from a list of forms of payment consisting of credit cards, debit cards, gift cards, digital and virtual currencies, coupons, cash, and wire transfer.
